(19) United States
(12) Patent Application Publication
(10) Pub. No.: US 2005/0094599 A1
(43) Pub. Date: May 5, 2005

(54) Method for handoff between PDSN

(76) Inventors: Jae Hong Ryu, Daejeon-city (KR); Won Ryu, Daejeon-city (KR); Hun Ki Lee, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/922,758

(22) Filed: Aug. 19, 2004

(30) Foreign Application Priority Data
Nov. 5, 2003 (KR) 2003-78114

(51) Int. Cl. H04Q 7/00

(52) U.S. Cl. 370/331

(57) ABSTRACT

A method for handoff between packet data serving nodes (PDSNs) The method for handoff between packet data serving nodes (PDSNs) provides packet services to a mobile node. A new PDSN receives subscriber information of a mobile node from at least one or more old PDSNs forming a communications network. The new PDSN recognizes the mobile node moving into a concerned area of the new PDSN and then transmits recognition information on the mobile node to an old PDSN to which the mobile node was connected. All received information on the mobile node is transmitted by the old PDSN based on the recognition information. A communication channel is established with the mobile node based on the received information. In the method, handoff is performed without reestablishing PPP. Accordingly, handoff between PDSNs can be performed faster, reducing the time needed for establishing a PPP session with a terminal and for terminating a previously set up PPP session.

This application claims priority from Korean Patent Application No. 03-78114, filed Nov. 05, 2003, the contents of which are incorporated herein by reference in their entirety.

### BACKGROUND OF THE INVENTION

1. Field of the Invention

The present invention relates to a method for handoff between packet data serving nodes (PDSNs), and more particularly, to a method for handoff by which handoff can be performed without reestablishing an unnecessary point-to-point protocol (PPP) connection that may occur in the process of performing handoff between PDSNs.

2. Description of the Related Art

Handoff methods in the prior art code division multiple access (CDMA) 2000 based wireless data communications can be broken down into handoff between packet control functions (PCFs) and handoff between PDSNs. The handoff between PCFs means a case where movement of a mobile node between PCFs happens, and PCFs change before and after the movement but are in an identical PDSN area. In this case, care of address (COA) used by the mobile node does not change such that mobility is guaranteed.

The handoff between PDSNs means a case where a mobile node moves to another PDSN area. In this case, since COA changes, the Internet Protocol (IP) address of the mobile node should be reset. For this, by using a foreign agent (FA) function of the PDSN, an IP address should be reassigned to the mobile node and the mobile node should register in a new FA. Only after this, the movement of the mobile node is completed. In other words, when a mobile node moves to another PCF in a PDSN area in a state where the mobile node is registered for mobile Internet protocol (MIP) in the PDSN, the PCF traces the mobility and a packet transmitted from an IP network to the mobile node is transmitted to the PDSN through a home agent (HA) according to the IP address of the mobile node. Then, the PDSN transfers the newly registered packet to the PCF through radio and packet RP interface and the PCF transfers it to the mobile node.

However, when a mobile node moves into another PDSN area, MIP is registered in the new PDSN. This is to inform the new PDSN of the mobile node's IP address movement. In this case, since a new FA registers in an HA, an IP packet to be transferred to the mobile node is transferred to the new PDSN from the HA and then transferred to the mobile node. Accordingly, loss of the user packets occurring during the delay time due to this point-to-point protocol (PPP) re-registration cannot be prevented.

That is, generally a contact point corresponding to the PPP of a terminal is a PDSN and since the terminal has moved into a new PDSN, a process to reestablish a PPP session should be performed in order to obtain a new PPP contact point.

In this situation, a method by which without performing unnecessary PPP reestablishment that may occur in handoff between PDSNs, handoff between PDSNs can be performed in a short time is needed.

### SUMMARY OF THE INVENTION

The present invention provides a method for handoff by which handoff can be performed without reestablishing an unnecessary PPP connection that may occur in the process of performing handoff between PDSNs.

According to an aspect of the present invention, there is provided a method for handoff between packet data serving nodes (PDSNs) which provide packet services to a mobile node, the method comprising: a new PDSN receiving subscriber information of a mobile node from at least one or more old PDSNs forming a communications network; the new PDSN recognizing the mobile node moving into a concerned area of the new PDSN and then transmitting recognition information on the mobile node to an old PDSN to which the mobile node was connected; receiving all information on the mobile node transmitted by the old PDSN based on the recognition information; and establishing a communication channel with the mobile node based on the received information.

### BRIEF DESCRIPTION OF THE DRAWINGS

The above objects and advantages of the present invention will become more apparent by describing in detail preferred embodiments thereof with reference to the attached drawings in which:

FIG. 1 is a schematic diagram of a signal flow showing a process for a mobile node to initially connect a call;

FIG. 2 is a schematic diagram of a signal flow showing a process to support mobility of a mobile node in which the process of FIG. 1 is performed twice;

FIG. 3 is a flowchart of the steps performed by a method for handoff between PDSNs according to the present invention; and

FIG. 4 is a schematic diagram showing a detailed process in which when a mobile node moved, the PPP process in the handoff method of FIG. 3 is omitted.

### DESCRIPTION OF THE PREFERRED EMBODIMENTS

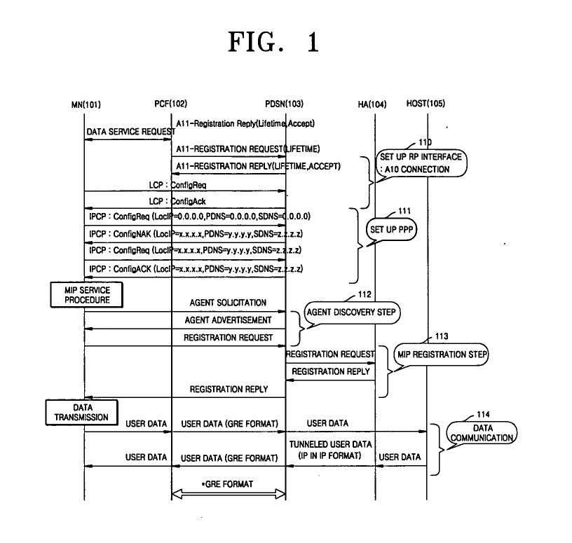

Referring to FIG. 1, when a mobile node 101 first connects a call, the mobile node 101 transfers a calling message containing a data service request to a packet control function (PCF) 102. A PCF plays a role for exchanging signals and traffic information between an access point (AP) and a PDSN when a call is established. The PCF 102 receiving the message transmits this information to a PDSN 103 to establish RP connection and performs a PPP connection setup procedure in step 110. Here, RP connection means an interface connection between a PCF and a PDSN for signaling (All) and user traffic (A10). The PDSN performs a foreign agent (FA) function in a mobile IP (MIP) and a network access server (NAS) function for setting up a PPP with a terminal. At this time, after the PDSN 103 allocates an address to the mobile node 101, the mobile node 101 completes PPP setup in step 111. The PDSN 103 transmits an advertisement message to the mobile node 101 periodically. Through this message, the mobile node 101 can confirm its current Internet contact point.

Meanwhile, when the mobile node 101 receives this advertisement message and transmits a mobile IP registration request (MIP RRQ) to the PDSN 103 in step 112, the PDSN 103 and a home agent (HA) 104 determine by retrieval whether or not the subscriber is one of those subscribers who qualify for MIP support, and then perform authentication. If the subscriber cannot be authenticated, the PDSN 103 includes an error in a mobile IP registration reply (MIP RPL) code, transmits the code to the mobile node 101 and terminates the call. However, if the subscriber is authenticated to perform normal MIP, the PDSN 103 maintains visitor information and by informing it to the mobile node 101, the registration procedure is finished in step 113. Thus, if a PPP is set up and a call is effectively established, actual data communications between the mobile node 101 and a host 105 are performed.

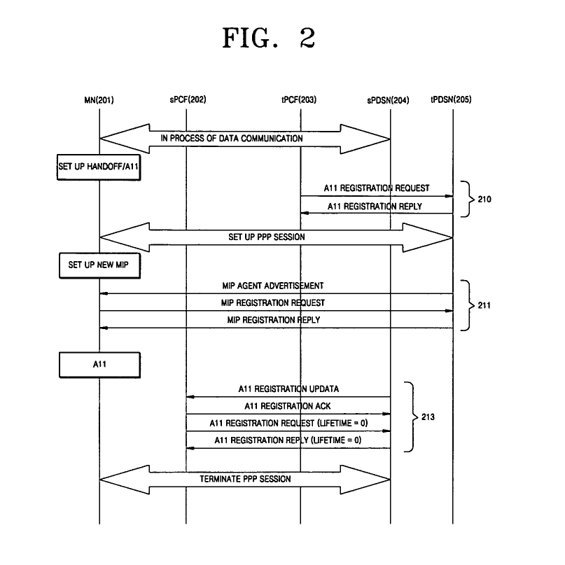

An example where handoff occurs will now be explained referring to FIG. 2. FIG. 2 is a schematic diagram showing a process to support mobility of a mobile node in which the process of FIG. 1 is performed twice. It is assumed that at present a mobile node 201 receives data services through source PCF (sPCF) 202 and source PDSN (sPDSN) 204 after connection to the Internet. Since the subscriber moves and handoff between sPCF202 and target PCF (tPCF) 203 and target PDSN (tPDSN) 205 occurs, a new RP session and PPP session should be set up. Here, target PCF and target PDSN mean a PCF and a PDSN of a network to which the subscriber should be connected because of the moving. This process will now be explained in detail. First, tPCF 203 transmits All RRQ message to tPDSN 205, and according to this, tPDSN 205 responds to PCF 203 with an RLP message in step 210. If this process is successful, a PPP session is reestablished between the mobile node 201 and tPDSN 205. Then, tPDSN 205 transmits an MIP advertisement message to the mobile node 201 and according to this, the mobile node 201 transmits an MIP registration request to tPDSN 205. In response to this, tPDSN 205 again transmits an MIP registration reply to the mobile node 201 and by doing so, a new MIP is set up in step 211. Then, All interface for signaling between sPCF 202 and sPDSN 204 is performed and the existing PPP session is terminated in step 213. Thus, when handoff between PDSNs is performed, processes for setting up a new PPP session and terminating an existing PPP session are needed such that unnecessary time and resources may be expended.

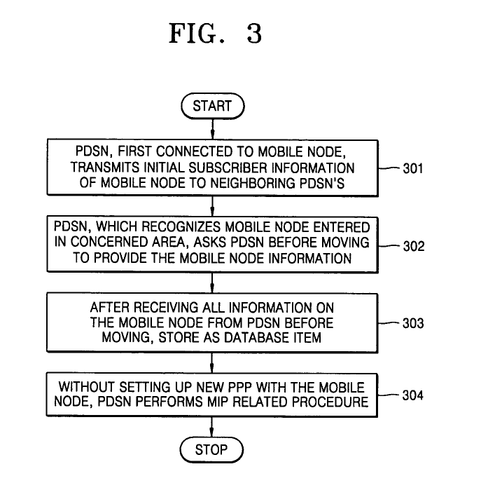

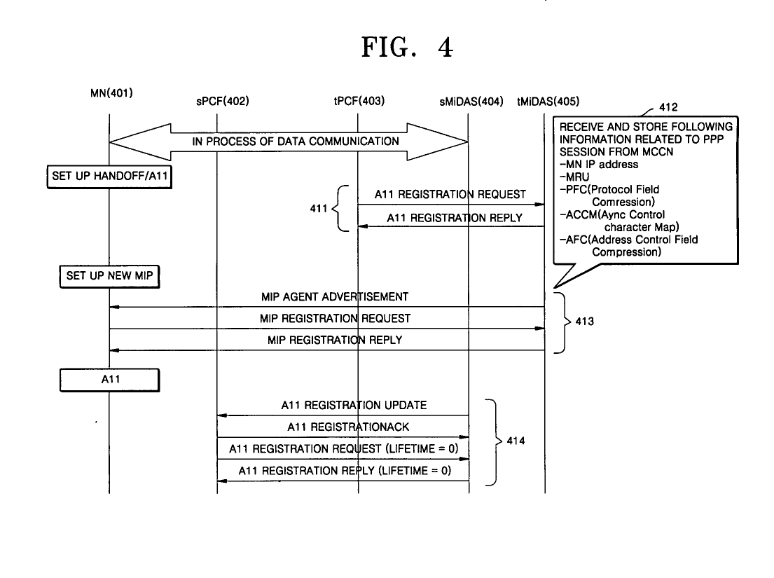

A preferred embodiment of the present invention to remove this problem will now be explained referring to FIGS. 3 and 4. FIG. 3 is a flowchart of the steps performed by a method for handoff between PDSNs according to the present invention, and FIG. 4 is a schematic diagram showing a detailed process in which when a mobile node moved, the PPP process in the handoff method of FIG. 3 is omitted.

Referring to FIGS. 3 and 4, shown is a situation where a mobile node 401 performs data communications with sMiDAS 404 before moving and then moves to another network and handoff is needed. For the following explanation, terms will now be defined. A new PDSN is a PDSN providing packet services to a newly connected mobile node which is moved into its concerned area. An old PDSN is a PDSN to which, before moving, the mobile node was connected. Also, in FIG. 4, MiDAS 404 and 405 is an apparatus performing the PDSN function and will be used as a synonym of PDSN. When the mobile node is first trying to connect a packet call, the old PDSN 404 makes subscriber information which the subscriber sets initially, shared by all PDSN neighboring the old PDSN in step 301. Here, subscriber information indicates an IP address of the subscriber, options defined when Icp and Ipcp are tried, and so on. In this state, if moving of the subscriber occurs, the new PDSN 405 senses that the subscriber moved into its concerned area and transfers the subscriber number and IP address of the mobile node to the old PDSN 404 to which the subscriber was connected before the moving, in step 302. Receiving this, the old PDSN 404 transfers all information of the subscriber to the new PDSN 405. Receiving the information, the new PDSN 405 stores the subscriber information as database items in step 303, and performs a procedure related to MIP with the mobile node 401 in step 304.

The embodiment will now be explained in detail as a signal flow between the mobile node and apparatuses in the wireless data communications network. PCF 403 transmits All registration request message to tMiDAS 405, and according to this, tMiDAS 405 transmits All registration response message to tPCF 403 in step 411. Thus, the process for RP setup is the same as in FIG. 2. However, instead of the PPP session setup procedure as shown in FIG. 2, PPP session related data, for example, MIN IP address, MRU, protocol control field compression (PFC), async control character map (ACCM), address control field compression (AFC), are received from sPDSN 404, to which the mobile node 401 was connected before the moving, and utilized as PPP setup resources of the mobile node in step 412. The tMiDAS 405 transmits an MIP advertisement message to the mobile node, which has moved into its concerned area, and according to this, the mobile node transmits an MIP registration request to tMiDAS 405. In response to this, tMiDAS 405 again transmits an MIP registration reply to the mobile node 405 and by doing so, a new MIP is set up in step 413. Then, All interface for signaling between sPCF 402, to which the mobile node belonged before the moving, and sMiDAS 404 is updated in step 414.

Meanwhile, when MIP setup is normally allocated, PPP resources set to sPDSN 404 may request termination or reestablishment by itself without negotiation with the mobile node, and accordingly, to the extent that the information is managed, the information is retained.

The method for handoff between PDSNs according to the present invention may be embodied in a code, which can be read by a computer, on a computer readable recording medium. The computer readable recording medium includes all kinds of recording apparatuses on which computer readable data are stored. The computer readable recording media includes ROMs, RAMs, CD-ROMs, magnetic tapes, hard disks, floppy disks, flash memories, and optical data storage devices. Also, it may be implemented in the form of a carrier wave (for example, transmitted over the Internet). Also, the computer readable recording media can be scattered on computer systems connected through a network and can store and execute a computer readable code in a distributed mode. Also, the font ROM data structure of the present invention can be implemented as computer readable codes on a computer readable recording medium such as ROMs, RAMs, CD-ROMs, magnetic tapes, hard disks, floppy disks, flash memories, and optical data storage devices.

According to the method for handoff between PDSNs of the present invention as described above, handoff is performed without reestablishing PPP and accordingly, handoff between PDSNs can be performed faster by a time (T1) needed for establishing a PPP session with a terminal and a time (T2) for terminating a previously set up PPP session. Here, T1 and T2 may vary according to the performance of a network. However, since at least 6 messages are transmitted and received during LCP negotiation, assuming that each message needs 0.1 second (based on the performance of a terminal), a time reduction effect of 1.2 seconds (=0.1*6*2 (including the termination process) can be achieved.

1. A method for handoff between packet data serving nodes (PDSNs) which provide packet services to a mobile node, the method comprising:
receiving a new PDSN subscriber information of a mobile node from at least one old PDSN forming a communications network;
the new PDSN recognizing the mobile node moving into a concerned area of the new PDSN and then transmitting recognition information on the mobile node to the old PDSN to which the mobile node was connected;
receiving all information on the mobile node transmitted by the old PDSN based on the recognition information; and
establishing a communication channel with the mobile node based on the received information.

2. The method of claim 1, wherein in receiving subscriber information, the new PDSN receives the subscriber information of the mobile node moving into the concerned area of the new PDSN from the old PDSN to which the mobile node was first connected.

3. The method of claim 1, wherein in transmitting recognition information, the new PDSN includes subscriber information and an IP address of the mobile node in the recognition information and transmits the recognition information.

4. The method of claim 1, wherein the received information includes predetermined data for establishing a point-to-point protocol (PPP) session, and setting up a PPP session with the mobile node.

5. A computer readable recording medium having embodied thereon a computer program for a method for handoff between PDSNs which provide packet services to a mobile node, the method comprising:
a new PDSN receiving subscriber information of a mobile node from at least one old PDSN forming a communications network;
the new PDSN recognizing the mobile node moving into a concerned area of the new PDSN and then transmitting recognition information on the mobile node to the old PDSN to which the mobile node was connected;
receiving all information on the mobile node transmitted by the old PDSN based on the recognition information; and
establishing a communication channel with the mobile node based on the received information.
